(19) United States
(12) Patent Application Publication
(10) Pub. No.: US 2006/0014462 A1
(43) Pub. Date: Jan. 19, 2006

(54) Reusable microfiber non-woven cleaning fabric

(76) Inventor: William Ralph Jones III, Humboldt, TN (US)

Correspondence Address: W. EDWARD RAMAGE, COMMERCE CENTER SUITE 1000, 211 COMMERCE ST, NASHVILLE, TN, 37201, US

(21) Appl. No.: 10/893,647

(22) Filed: Jul. 16, 2004

(51) Int. Cl. B32B 5/26

(52) U.S. Cl. 442/381

(57) ABSTRACT

A stratified non-woven cleaning fabric with one or more layers of fibrous components in conjunction with microfibers. The fabric comprises at least one layer consisting of a combination of deep groove microfibers with one or more other components such as cotton fibers, rayon fibers, polyester fibers, acrylic fibers, low melt binding material or resins, or absorbent gelling material. One or more additional layers can be added to the fabric, these additional layers potentially consisting of one or more components, including deep groove microfibers, cotton fibers, rayon fibers, polyester fibers, acrylic fibers, low melt binding material or resins, or absorbent gelling material. A method of constructing the invention also is disclosed.

### FIELD OF INVENTION

This invention relates to the combination of natural and synthetic fibers in conjunction with microfibers for use in forming a reusable non-woven cleaning fabric for applications such as floor care and wipers.

### BACKGROUND OF INVENTION

Beginning in the 1980s, Europe began utilizing cleaning tools utilizing the new fiber formation called micro-fibers or microfibers. Microfibers have been defined as fibers having a weight of less than 1.0 denier or as related to yield of 9000 meters weighing less than 9000 grams. These fibers have been refined over the years to be produced in three primary ways: splittable, “islands in the sea,” and deep groove technology.

The first two of these processes—splittable and “islands in the sea”—require the use of two polymers. The cleaning industry has primarily used the polymers of PET (polyester) and polyamides (nylon) in conjunction with the process of splittable microfiber. This process requires the fiber to be split to achieve the weight of less than 1.0 denier. The splitting process requires the use of either chemicals or aggressive mechanics to achieve the splitting. After achieving splitting, the fiber is considered microfiber. The effectiveness of the splitting process also determines the degree to which the microfiber is formed. Furthermore, due to the restrictions in laundering fabrics that have nylon, these fabrics can not accept strong alkalis such as bleach and must be laundered under lower temperatures than other synthetics such as polyester.

In contrast, the deep groove process utilizes only one polymer such as polyester and does not require splitting of the fiber. The deep groove process extrudes a single fiber with a total weight in excess of 1.0 denier but with multiple appendages that create a microfiber surface. The surface appears as a microscopic evergreen tree with its many branches.

The use of microfibers in the cleaning industry has found many applications. The minuteness of the microfibers allow them to penetrate the pores of the surfaces to be cleaned, thus achieving greater cleaning efficacy. Additional attributes have been the decrease of water and chemicals needed to achieve maximum cleaning of floors, walls, and glass surfaces as well as ergonomic advantages of this technique versus older methods of cleaning. Studies such as “Cleaning Methods with low Chemical Use” by the University Hospital in Lund Sweden (October 1998), and “Using Microfiber Mops in Hospitals” by University of California Davis Medical Center (November 2002) and published by the Environmental Protection Agency, validate these findings.

To date all microfiber fabrics or tools for cleaning have been of one of two constructions. These constructions have been either (1) knitted or woven fabric from a combination of microfiber and standard synthetic multi-filament yarns, or (2) non-woven fabric produced via air lay or hydro-entangling methods. The non-woven construction can consist of an intimate blend of various fibers including microfibers. Proctor and Gamble's “Swifter” is an example of such a non-woven construction. The first construction of knitted or woven fabric is the primary method used for multiple use, launderable applications, while the second construction of non-woven fabric is largely restricted to limited use applications. The first construction also costs substantially more than the second construction.

Therefore, there exists a need for a non-woven fabric containing microfibers that has the strength for multiple use cleaning applications and that can be laundered.

### SUMMARY OF THE INVENTION

The present invention comprises a stratified non-woven cleaning fabric with one or more layers of fibrous components in conjunction with microfibers. The fabric comprises at least one layer consisting of a combination of deep groove microfibers with one or more other components such as cotton fibers, rayon fibers, polyester fibers, acrylic fibers, low melt binding material or resins, or absorbent gelling material. One or more additional layers can be added to the fabric, these additional layers potentially consisting of one or more components, including deep groove microfibers, cotton fibers, rayon fibers, polyester fibers, acrylic fibers, low melt binding material or resins, or absorbent gelling material. The amount of microfiber used can affect the cleaning ability of the fabric. Similarly, the remaining fibrous materials are varied to add other attributes such as absorption, color, strength, and durability.

The present invention is manufactured by a combination of one or more parallel lines of machines, each of which open bales of various fibers, measures and blends prescribed amounts of fibers, mixes the fibers with optional gelling materials or additives, and then forms a fiber web or mat from the blended fibers. The stratified fabric is then formed by layering these fiber webs or mats in the desired sequence. If garnetts or cards are used to form the fiber webs or mats, then stratification is performed by cross lappers, which lay the fiber material on a conveyor and allow the fibers to be layered. Following stratification, the fabric may be densified, stitched, bonded, slit, perforated, and cut for distribution.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 shows a perspective view of an embodiment of the invention with four layers.

FIG. 2 shows an exploded perspective view of the individual layers of the embodiment of the invention shown in FIG. 1.

FIG. 3 shows a perspective view of the invention used in conjunction with a mopping tool.

FIG. 4 shows a sequence of steps in the method used to produce one embodiment of the invention.

### DETAILED DESCRIPTION

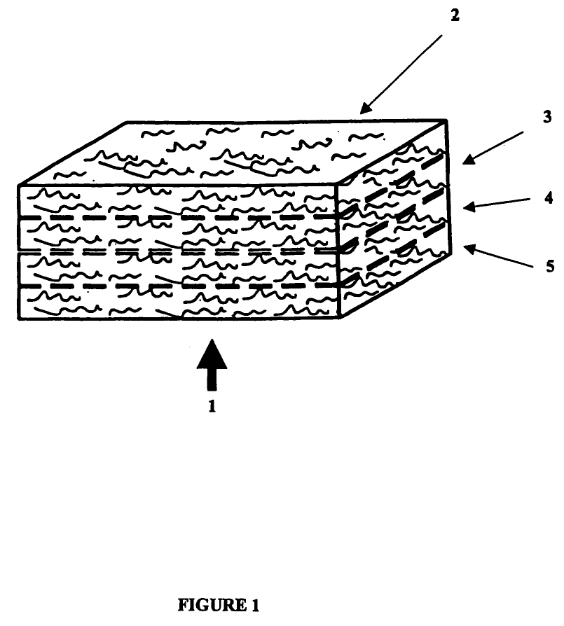

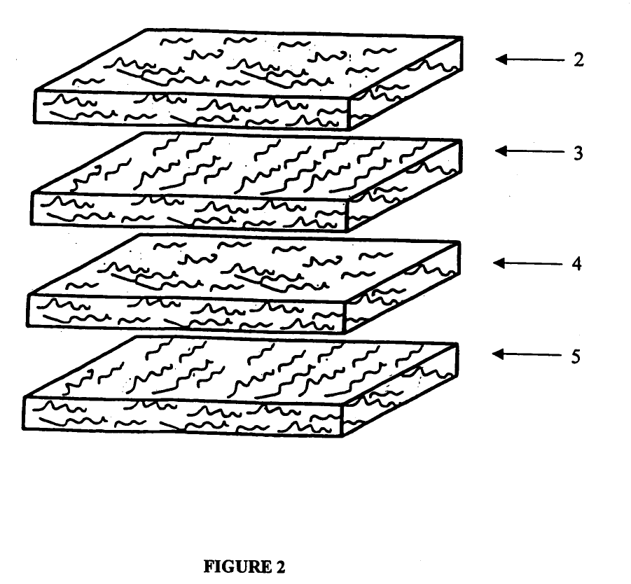

The present invention comprises a stratified, non-woven cleaning fabric with one or more layers of fibrous components used in conjunction with microfibers, particularly deep grove microfibers. In one exemplary embodiment, as shown in FIGS. 1 and 2, the fabric 1 comprises at least one layer 2 consisting of a combination of deep groove microfibers with one or more other components such as cotton fibers, rayon fibers, polyester fibers, acrylic fibers, low melt binding material or resins, or absorbent gelling material. One or more additional layers 3, 4, 5 can be added to the fabric. These additional layers 3, 4, 5 may consist of one or more components, including deep groove microfibers, cotton fibers, rayon fibers, polyester fibers, acrylic fibers, low melt binding material or resins, or absorbent gelling material.

The manner in which the invention is produced allows it to have specific layers 2, 3, 4, 5. The composition and structure of the layers can be varied depending on the desired result, such as the aggressiveness of the fabric on the cleaning surface. By stratifying the fabric so that there is more microfiber against the surface to be cleaned, for example, more aggressive cleaning is achieved. Thus, in one embodiment of the invention where the goal is to achieve maximum cleaning efficacy, deep groove microfibers are stratified on the outermost layer 1 to maximize contact with the surface to be cleaned. The remaining fibrous materials are stratified away from the cleaning surface to add other attributes such as absorption, color, strength, and durability.

In another embodiment, the invention also uses structuring of the layers to form a pattern on the face 6 of the fabric, such as a looped or sheared pile construction. A pattern can further enhance the degree of aggressiveness of the fabric on the surface to be cleaned. This has been seen as an advantage when trying to clean “scuff marks” from the surface of floors, for example.

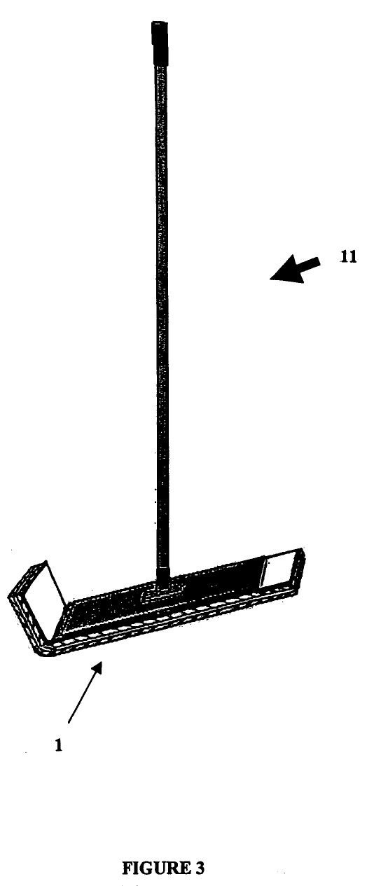

In yet another embodiment, as seen in FIG. 3, the product 1 is constructed in size and lateral flexibility such that it can literally bend and fold when used on traditional flat mopping tools 11. The invention thus can be used to clean baseboards next to the surface of the floor, for example, when the product 1 is situated to fold upward.

The combination of the various stratified fibers 2, 3, 4, 5 able to withstand repeated use and laundering with low melt binders for thermal bonding allows the fabric to withstand multiple launderings and reuse under normal commercial standards for heat and chemicals. In particular, the subject invention uses fibers (e.g., polyester, cotton, rayon, and acrylic) often found in traditional cleaning tools, in conjunction with deep grove microfibers. In contrast, microfibers utilizing two polymers produced by methods such as the splittable and “islands in the sea” processes, and which incorporate polyamides (nylon) in their construction, must be laundered with special care using low heat and no strong alkalis such as forms of bleach commonly used in the commercial or home care cleaning process.

The thermal bonding process uses heat-sensitive resins or binder fibers. Heat sensitive resins can be applied in solid form during the formation of one or more fiber layers 2, 3, 4, 5 and when heated, the resins melt and flow to the intersection of the individual fiber strands. When the fabric is cooled the melted resins solidify, forming bonds or “glue” joints where the fibers intersect. Binder fibers may be staple fiber with a significantly lower melting point than the other fibers in the blend. The binder fiber may also be a bi-component sheath-core fiber where the sheath component is a polymer with a low melting point with the core being a polymer with a relatively high melting point. The bonds that are formed after the fabric is heated and cooled allow the fibers to remain in the orientation in which they were initially processed.

In one embodiment of the subject invention, absorption is approximately five times its weight, and is equivalent to or better than existing products produced in other constructions. The absorption amount can be varied based on the exact combination of the stratified fibers. Depending on the use of the invention, absorption can be critical or not. As a floor tool for attracting dust, static charge rather than absorption is important. As a damp cleaning floor tool or rag for light cleaning or disinfecting, absorption is needed only to hold and transfer the disinfectant. As a wet cleaning floor tool, absorption can be critical in the transfer of fluids from a floor to a holding container.

The strength and durability of the fabric is enhanced by the densification of the stratified layers. Densification can be achieved through compression (with or without heat), calendaring, mechanical needling (which causes the fibers to be mechanically interlocked), stitch bonding, or other densifyng means known to those of the skill in the art of fiber processing.

Fibers can be varied within the invention as well as the weight and density to achieve the desired end product 1. In one exemplary embodiment, the invention generally has a thickness falling within a range of 0.25 inches to 1.00 inches, and a weight of between 1 ounce per square foot to 6 ounces per square foot. The invention can be packaged in pre-slit widths that match existing hardware in the cleaning industry. The pre-slit widths can then either be cut to length by a wholesaler or an end user, or placed in roll form in packaging such that it can be pulled from the package and cut to length by an end user. The material can be marked by print or perforation at 6-inch (or other) intervals, as a means to determine total length needed. The width would be determined based on the end use.

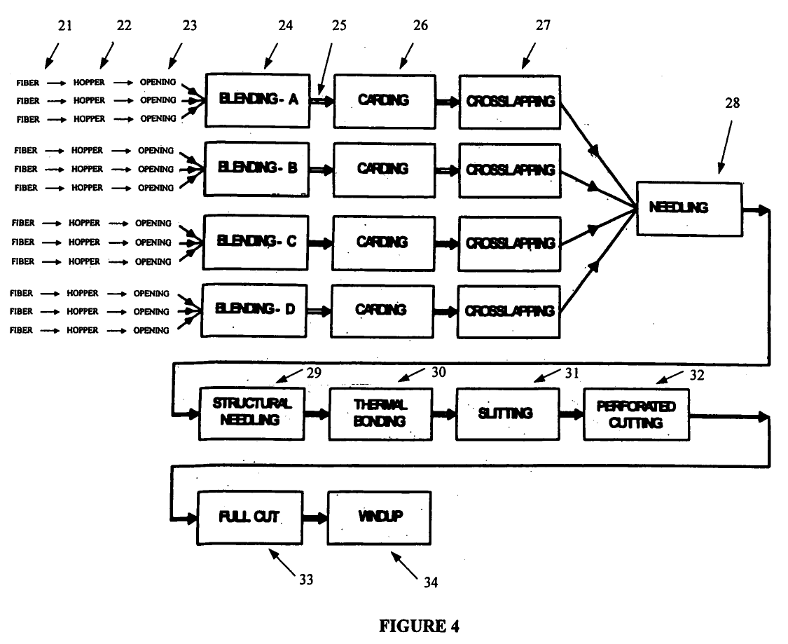

To manufacture the present invention, as shown in FIG. 4, fiber from compressed bales 21 is placed first into hoppers or onto a conveyor or other feeder device 22, where openers 23 such as bale openers and/or fine openers (Wise Industries, Kings Mountain, N.C.), begin to open the fiber bales or clumps 21 and prepare the fibers for processing. Next, in the blending phase, the fibers are blended using multiple blending feeders 24, with different or like kinds of fiber, that weigh out specific amounts of fiber in order to achieve a precise “blend level” of various fibers. The precise blend level is achieved through electronically controlled weighing devices or through other forms of precise metering that provide for sufficient accuracy of the blend. The fiber is then collected on a common conveyor or air transport system 25 where the fiber is moved to the next processing stage or optionally moved to a mixing chamber and/or additional opener (not shown). Additives, such as absorbent gelling material, may optionally be added in the mixing chamber, opening device or air transport system. Other types of chemicals or additives may also be added to enable processing of the fiber for its intended use.

Once opened and blended, a fiber web or mat is formed from the blend by garnetts, cards, airlaying machines or volumetric chute-type machines 26. If garnetts or cards are used, then following these machines are cross lappers 27, which lay the material on a conveyor and allow the fibers to be layered in height to provide for the proper weight basis of the mat of fibers and the desired width of the finished product. When multiple machines supported by separate blending hoppers are put in line and feeding cross lappers, then a “stratified” product can be produced. This occurs when one machine layers a specific blend of fibers on top of another layer of different fibers thus forming a product with differing layers. This is the basis for the current invention that allows for a layered or “stratified” reusable product.

These “stratified” fibers then are made denser via steps which may include any of the following processes singularly or in combination to achieve the correct density: use of compression rolls (heated or unheated), needling 28 in one or two steps, stitch or structural bonding 29, hydro-entangling, or other densifying processes known in the industry. After densifying, the product is then thermally bonded 30 via a thermal bonding oven, calendar, radio frequency, or other bonding device. It is at this stage that the thermal bonding fibers or resins are activated. Bonds, or “glue joints” are formed where fibers intersect, the product is cooled and transported from the thermal bonding machinery. Optionally, chemical additives, resins, and absorbent gelling material may be applied after web or fiber mat formation and before entry into or after exit from the bonding oven.

When the mat of stratified fibers exits the bonding machinery, the product may be slit 31 to the desired width, marked for linear lengths (such as with perforations) 32, cut to the desired length 33, and packaged 34. Packaging can be in mill parent rolls with multiple slit rolls packaged together for repackaging by a distributor, or in boxes ready for consumption by the end user.

The end result is a superior product with decreased cost that is produced in a layered or stratified form, comprising a combination of microfiber and/or blends of cotton/viscose/synthetics in various portions of the product.

The invention will be further described by the following non-limiting example:

### EXAMPLE 1

A reusable microfiber non-woven cleaning fabric with multiple layers is produced by placing fibers for one layer of the product into one set of hoppers that feed two of three garnetts while additionally passing low melt fiber through a fine opener, electronically weighing the various fibers and depositing them on a common conveyor, feeding the various fibers through a mixing chamber, and running them correspondingly through two garnetts. Simultaneously and in the same manner a second blend of fibers is processed and run into a third garnett. The first two garnetts lay their fiber on a crosslapper while the third garnett lays its fiber on top of the fibers deposited by the first two garnets thus creating a “stratified” layer on top of two “base” layers. This “stratified” layer can effectively be placed on top, inside, or on the bottom of the product depending on which of the three garnetts are utilized to make the “stratified” layer. The product moves from crosslapping through a tacking needleloom followed by a structuring needleloom, then it is thermally bonded, slit, cut to length, and packaged by means of techniques known to those of skill in the textile manufacturing industry. The fiber blend consists of the following by weight: a) 33.33% in a “stratified layer” containing 80% deep groove microfiber and 20% polyester/polyester (PET/PET) sheath core binder fiber with the sheath having a 100 degree C. melting point and the core having a 260 degree C. melting temperature; and b) 66.67% in two “base” layers containing 25% color acrylic, 20% polyester/polyester (PET/PET) sheath core binder fiber same as in “a)” above, 25% cotton, and 30% polyester. Product thickness is approximately 4.8 mm with a basis weight of 650 grams per square meter. The product performed well under use as a damp mopping tool for cleaning patient rooms and in launderability at University of California Davis Medical Center research trials the week of Apr. 12^{th}, 2004.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A cleaning fabric, comprising one or more layers of non-woven fabric wherein at least one layer contains microfibers.

2. The fabric of claim 1, wherein the microfibers are deep groove microfibers.

3. The fabric of claim 1, wherein a first layer contains microfibers in combination with a blend of other fibers, and a second layer contains a blend of other fibers.

4. The fabric of claim 3, wherein the other fibers in the first or second layer, or both, comprise one or more of cotton, rayon, polyester, acrylic, or gelling material.

5. The fabric of claim 3, wherein the other fibers in the first or second layer, or both, include a material with a low melting point.

6. The fabric of claim 3, wherein the other fibers in the first or second layer, or both, include an absorbent gelling material.

7. The fabric of claim 1, wherein the layer containing microfibers is one of the outermost layer of the fabric.

8. The fabric of claim 7, wherein the outer side of the layer containing microfibers forms a looped or sheared pile pattern.

9. The fabric of claim 1, wherein the amount of microfibers in the layer is variable.

10. The fabric of claim 1, wherein the layers are bendable.

11. The fabric of claim 1, wherein the layers are thermally bonded.

12. The fabric of claim 11, further wherein the layers are thermally bonded with a heat-sensitive resin.

13. The fabric of claim 11, further wherein the layers are thermally bonded with a binder fiber comprising a staple fiber with a lower melting point than other fibers in the fabric.

14. The fabric of claim 11, further wherein the layers are thermally bonded with a binder fiber comprising a bi-component fiber comprising a sheath and a core, wherein the sheath comprises a polymer with a low melting point and the core comprises a polymer with a higher melting point than the sheath.

15. The fabric of claim 1, wherein the layers are densified.

16. The fabric of claim 1, wherein the layers are densified by compression, calendaring, mechanical needling, or stitch bonding.

17. The fabric of claim 1, wherein the fabric has a thickness of one inch or less, and a weight of 1 to 6 ounces per square foot.

18. The fabric of claim 1, wherein the fabric is cut in pre-slit widths.

19. The fabric of claim 1, wherein the fabric is marked by print or perforation at intervals.

20. A method of forming a non-woven cleaning fabric from fibers, comprising the steps of:
preparing fibers for processing;
transporting the prepared fibers to one or more processing devices;
forming a fiber web or mat layer from the prepared fibers;
combining the fiber web or mat layer with one or more other fiber web or mat layers formed in substantially the same manner by parallel processes to form a stratified fabric.

21. The method of claim 20, wherein the step of preparing fibers for processing further comprises:
placing fibers from compressed bales into hoppers or onto a conveyor or other feeder device;
opening the compressed bales;
weighing out specific amounts of fibers;
transporting fibers to a blending chamber;
adding optional additives to the blending chamber; and
blending the fibers with any additives.

22. The method of claim 20, wherein the fiber web or mat layer is formed with garnetts, cards, airlaying machines, or volumetric chute-type machines.

23. The method of claim 22, wherein the fiber webs or mat layers formed with garnetts or cards are combined to form a stratified fabric by cross lapping.

24. The method of claim 20, further comprising the steps of:
densifying the stratified fabric one or more times;
creating an optional design or pattern in the topmost fiber layer of the stratified fabric; and
thermally bonding the fiber layers of the stratified fabric together.

25. The method of claim 24, further comprising the steps of:
marking the stratified fabric with print or perforations at certain intervals;
cutting the stratified fabric to certain widths; and
packaging the stratified fabric for distribution or end-use.

26. The method of claim 23, wherein the stratified fabric is marked at six-inch intervals.
